(19) United States
(12) Patent Application Publication
(10) Pub. No.: US 2024/0139827 A1
(43) Pub. Date: May 2, 2024

(54) CUTTING INSERT AND CUTTING TOOL INCLUDING THE SAME

(71) Applicant: YG-1 Co, Ltd., Incheon (KR)

(72) Inventors: Taeseon Ham, Chungju-si (KR); Babushkin Anton, Chungju-si (KR); Geunwoo Park, Chungju-si (KR); Yeong Dong KIM, Chungju-si (KR)

(21) Appl. No.: 18/479,026

(22) Filed: Sep. 30, 2023

(30) Foreign Application Priority Data
Nov. 2, 2022 (KR) 10-2022-0144407

(51) Int. Cl. B23B 27/16

(52) U.S. Cl. CPC B23B 27/1611

(57) ABSTRACT

A cutting insert may include a coupling part, a cutting part, a connection part, a clamping part, and a recess part. Also, the cutting part may include a cutting body part through which the clamping part passes and a cutting edge disposed along an outer circumference of the cutting body part, and the cutting edge may include a main cutting edge provided in plurality to cut the workpiece, a corner cutting edge provided in number corresponding to that of the main cutting edge and extending curvedly from the main cutting edge, a minor cutting edge provided in number corresponding to that of the corner cutting edge and extending from the corner cutting edge to cut the workpiece, and an inclined cutting edge having one end connected to the minor cutting edge and the other end connected to the main cutting edge.

### CROSS-REFERENCE TO RELATED APPLICATIONS

This U.S. non-provisional patent application claims priority under 35 U.S.C. § 119 of Korean Patent Application No. 10-2022-0144407, filed on Nov. 2, 2022, the entire contents of which are hereby incorporated by reference.

### BACKGROUND

The present invention relates to a cutting insert and a cutting tool including the same, and more particularly, to a cutting insert capable of easily discharging a chip and performing effective cutting and a cutting tool including the same.

In general, a cutting insert is clamped to a cutting tool mounted to a machine tool and used to cut a workpiece made of iron, a nonferrous metal, and a non-metallic material. The cutting insert is broadly classified into a double-sided cutting insert having an upper cutting edge disposed at a boundary between a top surface and a side surface thereof and a lower cutting edge disposed at a boundary between a bottom surface and the side surface thereof and a single-sided cutting insert having a cutting edge only at a boundary between the top surface and the side surface.

Furthermore, the cutting edge includes a main cutting edge disposed at a boundary between the top surface and a major side surface thereof to mainly cut an unnecessary portion of the workpiece and a minor cutting edge disposed at a boundary between the top surface and a minor side surface thereof to mainly cut a bottom surface of the workpiece. Also, according to the number of corners formed by the main cutting edge and the assistant cutting edge when viewed from above, a cutting insert having n corners is referred to as “n corner cutting insert”.

FIG. 1 is a view illustrating a conventional cutting tool. FIG. 2 is a view illustrating a conventional cutting insert. Referring to FIGS. 1 and 2, a conventional cutting tool 9′ includes a body coupling part 91′ coupled to a machine tool and an insert coupling part 93′ coupled with a cutting insert 0′.

The body coupling part 91′ may include a machine coupling part 911′ coupled to the machine tool at a center thereof. The machine coupling part 911′ has a hole shape passing through the body coupling part 91′ so that another component of the machine tool is inserted and coupled thereto.

Also, the insert coupling part 93′ may include an insert coupling body part 931′ coupled to the body coupling part 91′ and an insert contact coupling part 933′ provided in plurality along an outer circumference of the insert coupling body part 931′ and coupled with the cutting insert 0′.

Specifically, the cutting insert 0′ may be coupled to the insert contact coupling part 933′ through a separate fastening member and perform cutting of the workpiece through rotation.

Referring to FIG. 2, a conventional cutting insert 0′ may include a main cutting edge 131′, a corner cutting edge 133′, a minor cutting edge 135′, and an inclined cutting edge 137′. Specifically, in a clockwise direction of FIG. 2, the main cutting edge 131′ may be connected to the inclined cutting edge 137′, the inclined cutting edge 137′ may be connected to the minor cutting edge 135′, and the minor cutting edge 135′ may be connected to the corner cutting edge 133′.

More specifically, the main cutting edge 131′ may extend in the form of a straight line having a flat shape, and the inclined cutting edge 137′ may extend in the form of a straight line having a flat shape while forming an obtuse angle with the main cutting edge 131′. Thus, in the conventional cutting insert 0′, a space formed between the inclined cutting edge 137′ and a bottom surface of the workpiece may be narrow, and a chip generated during cutting may be caught between the cutting insert 0′ and the cutting tool 9′ to collide with a surface of the workpiece, thereby causing cutting quality to be degraded.

Thus, currently, researches are being actively conducted to improve the cutting quality by easily discharging the chip generated during cutting by using the cutting insert 0′.

Also, the conventional cutting insert 0′ may include a cutting part 13′ including a main cutting edge 131′, a corner cutting edge 133′, a minor cutting edge 135′, and an inclined cutting edge 137′ and a coupling part B′ coupled to an insert contact coupling part 933′.

Furthermore, the cutting insert 0′ may include a main cutting upper connection part 311′ extending from the main cutting edge 131′ toward the coupling part B′, and the main cutting upper connecting part 311′ may be perpendicular to the coupling part B′. Accordingly, a clearance surface of the cutting edge, which does not participate in a substantial cutting processing, may be interfered with the workpiece during ramping and the cutting quality may be degraded.

Thus, researches for improving the cutting quality through a detailed design of the main cutting upper connection part 311′ and the coupling part B′ are actively being conducted.

### SUMMARY

Embodiments of the present invention provide a cutting insert that easily discharges a chip during cutting by including a recess part.

Embodiments of the present invention also provide a cutting insert in which a corner connection main cutting edge has an inclination less than that of an inclined connection main cutting edge to distribute stress concentrated on the corner cutting edge, thereby improving durability.

Embodiments of the present invention also provide a cutting insert that has an improved cutting performance and easily discharges a chip through an optimized design of a connection part.

Embodiments of the present invention provide a cutting insert including a recess part.

Specifically, the cutting insert includes: a coupling part coupled to a tool; a cutting part spaced apart from the coupling part to cut a workpiece; a connection part configured to connect the cutting part and the coupling part; a clamping part configured to pass through the coupling part, the cutting part, and the connection part; and a recess part extending from an outer circumferential surface of the cutting part to an outer circumferential surface of the coupling part along an outer circumferential surface of the connection part and recessed toward the clamping part.

The cutting part includes: a cutting body part through which the clamping part passes; and a cutting edge disposed along an outer circumference of the cutting body part, cutting edge includes: a main cutting edge provided in plurality to cut the workpiece; a corner cutting edge provided in number corresponding to that of the main cutting edge and extending curvedly from the main cutting edge; a minor cutting edge provided in number corresponding to that of the corner cutting edge and extending from the corner cutting edge to cut the workpiece; and an inclined cutting edge having one end connected to the minor cutting edge and the other end connected to the main cutting edge, and the recess part extends from the inclined cutting edge to the coupling part along the connection part.

In an embodiment, the recess part may extend continuously to the coupling part along the connection part and has a radius of curvature of 0.5 to 3.

In an embodiment, the recess part may have a radius of curvature of 1.5 to 2.5.

In an embodiment, the main cutting edge may include a first main cutting edge, a second main cutting edge, and a third main cutting edge, the corner cutting edge may include a first corner cutting edge connected to the first main cutting edge, a second corner cutting edge connected to the second main cutting edge, and a third corner cutting edge connected to the third main cutting edge, the minor cutting edge may include a first minor cutting edge extending from the first corner cutting edge to the second main cutting edge, a second minor cutting edge extending from the second corner cutting edge to the third main cutting edge, and a third minor cutting edge extending from the third corner cutting edge to the first main cutting edge, and the inclined cutting edge may include a first inclined cutting edge configured to connect the first minor cutting edge and the second main cutting edge, a second inclined cutting edge configured to connect the second minor cutting edge and the third main cutting edge, and a third inclined cutting edge configured to connect the third minor cutting edge and the first main cutting edge.

In an embodiment, the recess part may include a first recess part defined in the first inclined cutting edge, a second recess part defined in the second inclined cutting edge, and a third recess part defined in the third inclined cutting edge.

In an embodiment, each of the first main cutting edge, the second main cutting edge, and the third main cutting edge may extend in the form of a curve having a radius of curvature equal to or greater than a predetermined value, each of the first corner cutting edge, the second corner cutting edge, and the third corner cutting edge may have an acute angle, each of the first minor cutting edge, the second minor cutting edge, and the third minor cutting edge may extend to be flat, and centers of the first inclined cutting edge, the second inclined cutting edge, and the third inclined cutting edge may be recessed toward the clamping part.

In an embodiment, the connection part may include: a first connection part connected to the first main cutting edge, the third inclined cutting edge, and the third minor cutting edge; a second connection part connected to the second main cutting edge, the first inclined cutting edge, and the first minor cutting edge; and a third connection part connected to the third main cutting edge, the second inclined cutting edge, and the second minor cutting edge.

In an embodiment, the cutting part may have an area greater than that of the coupling part, and the connection part may extend obliquely from the cutting part to the coupling part toward a center of the clamping part.

In an embodiment, the connection part may include: a main cutting connection part connected to the main cutting edge; an inclined cutting connection part connected to the inclined cutting edge; and a minor cutting connection part connected to the minor cutting edge.

In an embodiment, an angle between an extension line of the main cutting connection part and an extension line of the minor cutting connection part may be an obtuse angle, and the inclined cutting connection part may be recessed inward toward the clamping part to form the recess part.

In an embodiment, the main cutting connection part may include: a main cutting upper connection part connected to the main cutting edge; a main cutting central connection part extending from the main cutting upper connection part to the coupling part; and a main cutting lower connection part extending from the main cutting central connection part to the coupling part.

In an embodiment, an angle between an outer end of the main cutting upper connection part and a central axis of the clamping part may be 8° to 12°, an angle between an outer end of the main cutting central connection part and the central axis of the clamping part may be 14° to 18°, and an angle between an outer end of the main cutting lower connection part and the central axis of the clamping part may be 18° to 22°.

In an embodiment, an angle between the outer end of the main cutting upper connection part and the central axis of the clamping part may be 9.5° to 10.5°, an angle between the outer end of the main cutting central connection part and the central axis of the clamping part may be 15.5° to 16.5°, and an angle between the outer end of the main cutting lower connection part and the central axis of the clamping part may be 19.5° to 20.5°.

In an embodiment, the angle between the outer end of the main cutting upper connection part and the central axis of the clamping part may be less than that between an outer end of the minor cutting connection part and the central axis of the clamping part.

In an embodiment, an angle between the outer end of the minor cutting connection part and the central axis of the clamping part may be 16° to 20°.

In an embodiment, an angle between the outer end of the minor cutting connection part and the central axis of the clamping part may be 17.5° to 18.5°.

In an embodiment, the main cutting edge may include: a corner connection main cutting edge connected to the corner cutting edge; and an inclined connection main cutting edge extending from the corner connection main cutting edge to the inclined cutting edge and having an inclination greater than that of the corner connection main cutting edge.

In an embodiment, an angle between a tangent line of the corner connection main cutting edge and the coupling part may be 0° to 4°, and an angle between a tangent line of the inclined connection main cutting edge and the coupling part may be 3° to 7°.

In an embodiment, an angle between the tangent line of the corner connection main cutting edge and the coupling part may be 1.5° to 2.5°, and an angle between the tangent line of the inclined connection main cutting edge and the coupling part may be 4.5° to 5.5°.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a perspective view illustrating a conventional cutting tool;

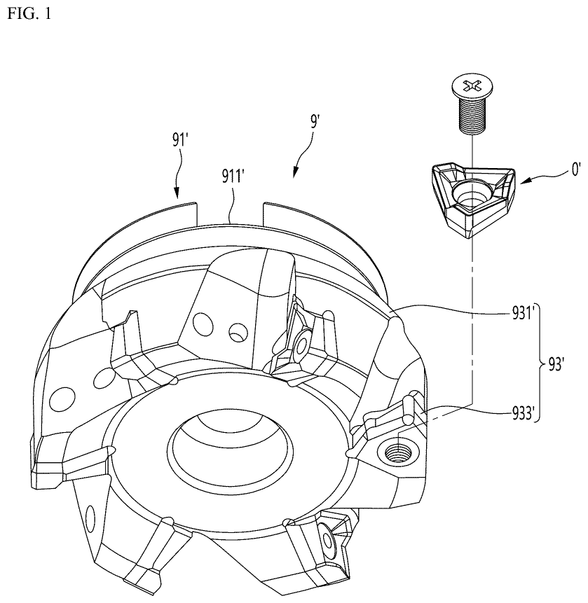

FIG. 2A and FIG. 2B are a view illustrating a conventional cutting insert;

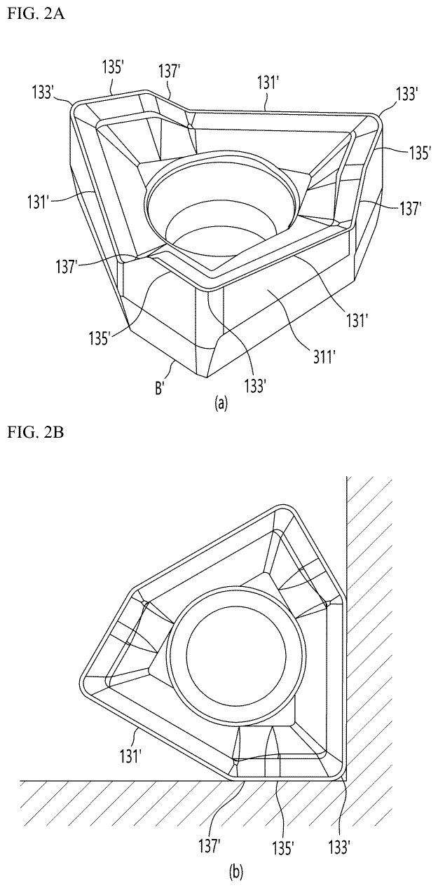

FIG. 3 is a view illustrating a cutting tool according to an embodiment of the present invention;

FIG. 4A and FIG. 4B are a perspective view illustrating a cutting insert according to an embodiment of the present invention;

FIG. 5 is a view illustrating a recess part according to an embodiment of the present invention;

FIG. 6A and FIG. 6B are an area view illustrating a coupling part and a cutting part of the cutting insert according to an embodiment of the present invention;

FIG. 7 is a side view illustrating the cutting insert according to an embodiment of the present invention;

FIG. 8A and FIG. 8B are a cross-sectional view of FIG. 7;

FIG. 9 is a view illustrating an angle formed between components of the cutting insert according to an embodiment of the present invention; and

FIG. 10A and FIG. 10B are a photograph showing cutting quality comparison between the conventional cutting insert and the cutting insert according to an embodiment of the present invention.

### DETAILED DESCRIPTION

Hereinafter, specific embodiments of the present invention will be described in detail with reference to the accompanying drawings so that this invention is easily implemented by those skilled in the art.

The present disclosure may, however, be embodied in different forms and should not be construed as limited to the embodiments set forth herein. In the drawings, the thicknesses of layers and regions are exaggerated for clarity. Like reference numerals in the drawings denote like elements, and thus their description will be omitted.

In this specification, overlapped descriptions on the same component are omitted.

Also, in this specification, when it is described that a component is ‘coupled to’, ‘engaged with’, or ‘connected to’ another component, it should be understood that the element may be directly coupled or connected to the other element, but still another element may be “coupled to”, “engaged with”, or “connected to” the other element therebetween. On the other hand, when it is described that a component is ‘directly coupled to’ or ‘directly connected to’ another component, it should be understood that there are no other components therebetween.

The present invention may, however, be embodied in different forms and should not be construed as limited to the embodiments set forth herein.

The terms of a singular form may include plural forms unless referred to the contrary.

The meaning of “include,” “comprise,” “including,” or “comprising,” specifies a property, a region, a fixed number, a step, a process, an element and/or a component but does not exclude other properties, regions, fixed numbers, steps, processes, elements and/or components.

The word ‘and/or’ means that one or more or a combination of relevant constituent elements is possible. In the specification, ‘A or B’ may include ‘A’, ‘B’, or ‘both A and B’.

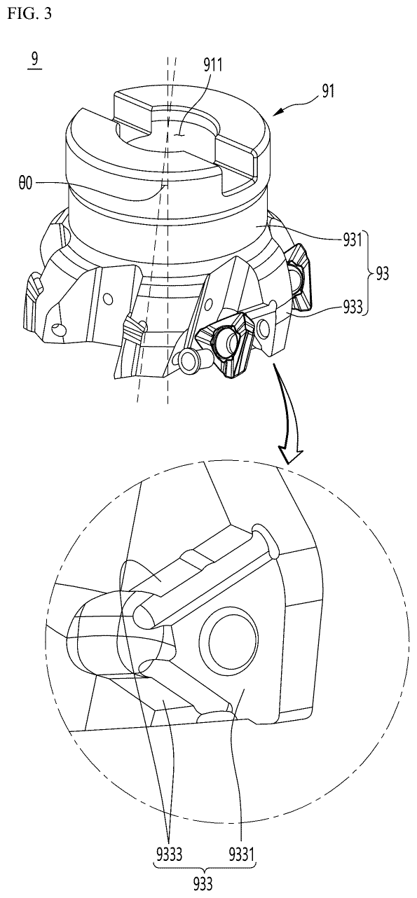

FIG. 3 is a view illustrating a cutting tool according to an embodiment of the present invention. Referring to FIG. 3, a cutting tool 9 according to an embodiment of the present invention may include a body coupling part 91 coupled to a machine tool and an insert coupling part 93 to which a cutting insert 0 is coupled.

The body coupling part 91 may include a machine coupling part 911 coupled to the machine tool at a center thereof. The machine coupling part 911 has a hole shape passing through the body coupling part 91 so that another component of the machine tool is inserted and coupled thereto.

Also, the insert coupling part 93 may include an insert coupling body part 931 coupled to the body coupling part 91 and an insert contact coupling part 933 provided in plurality along an outer circumference of the insert coupling body part 931 and coupled with the cutting insert 0.

Specifically, the insert contact coupling part 933 may include an insert seating part 9331 and an insert support part 9333. As one surface of the insert coupling body part 931 is recessed inward, a coupling part B of the cutting insert 0, which will be described later, may be seated on the insert seating part 9331.

The insert support part 9333 may be connected to the insert seating part 9331 and disposed to surround at least a portion of a connection part 3 of the cutting insert 0 that will be described later, thereby supporting the connection part 3. Specifically, the insert support part 9333 may have a shape corresponding to the connection part 3, a first connection part 3a that will be described later may surround a portion of the connection part 3, a second connection part 3b may surround an entire portion thereof, and a third connection part 3c may be provided to expose the entire portion. Also, the second connection part 3b may surround 90% or more of the entire portion. Thus, the insert support part 9333 may provide optimized support force to the cutting insert 0 and allow the cutting insert 0 to efficiently cut the workpiece.

Also, the insert seating part 9331 may form an obtuse angle with the insert support part 9333 to allow the cutting insert 0 to be easily coupled and increase a contact area with the cutting insert 0, thereby improving support force.

Furthermore, the insert seating part 9331 may form a predetermined angle with a rotation axis of the body coupling part 91. Specifically, the insert seating part 9331 may form a positive angle of 5° to 15° with the rotation axis of the body coupling part 91 to improve a cutting efficiency.

More specifically, the insert seating part 9331 may form an angle of 8° to 12° with the rotation axis of the body coupling part 91 to further improve the cutting efficiency.

The cutting insert 0 may be coupled to the insert seating part 9331 through a separate fastening member. For example, the fastening member may include a clamping screw. However, the fastening member is not limited to the clamping screw. The fastening member may include all sorts of members as long as the members are capable of coupling the insert seating part 9331. Alternatively, the fastening member may use a coupling method other than the coupling method through the fastening member as necessary.

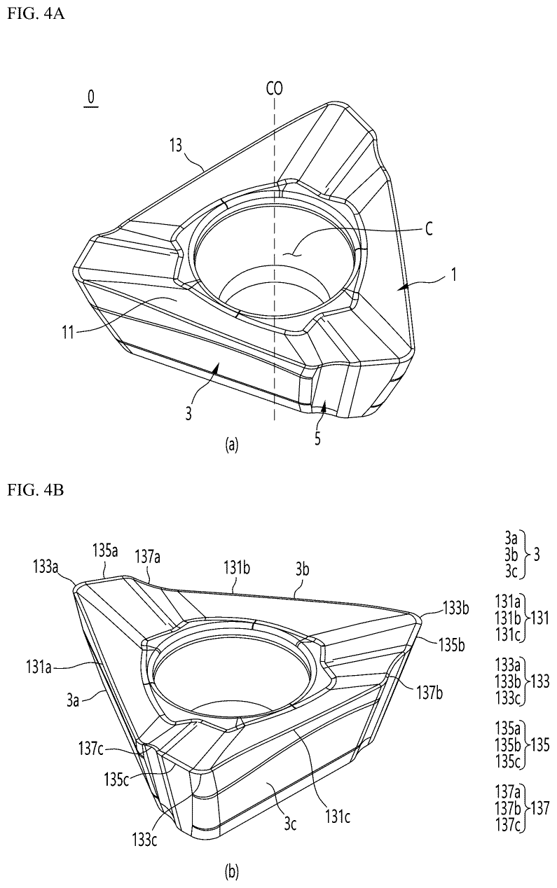

FIG. 4 is a perspective view illustrating the cutting insert according to an embodiment of the present invention. Specifically, FIGS. 4(a) and 4(b) are perspective views illustrating the cutting insert at different angles.

Referring to FIG. 4, the cutting insert 0 according to an embodiment of the present invention may include a coupling part B, a cutting part 1, a connection part 3, a clamping part C, and a recess part 5. The coupling part B may be coupled to the tool.

Specifically, the coupling part B that is a component seated in direct contact with the insert seating part 9331 may be a bottom surface of the cutting insert 0. Also, the coupling part B may have a flat shape together with the insert seating part 9331 to be easily seated and increase a contact area, thereby improving coupling force.

The cutting part 1 may be spaced apart from the coupling part B to cut the workpiece. That is, the cutting part 1 may contact the workpiece to remove a portion of the workpiece according to a design. Also, the cutting part 1 may be a top surface of the cutting insert 0.

The connection part 3 may connect the cutting part 1 to the coupling part B. That is, the connection part 3 may be a side surface of the cutting insert 0 and have a cross-sectional shape corresponding to the cutting part 1 and the coupling part B. That is, the cutting part 1 and the coupling part B may have similar cross-sections having different sizes.

Also, the connection part 3 that is an important coupling surface of the cutting insert 0 together with the coupling part B may provide coupling force when coupled to the tool.

The clamping part C may pass through the coupling part B, the cutting part 1, and the connection part 3. That is, the above-described separate fastening member may pass through the clamping part C until the insert seating part 9331 to fix the cutting insert 0 to the insert seating part 9331. Also, the clamping part C may pass through centers of the coupling part B, the cutting part 1, and the connection part 3 to adjust overall balance of the cutting insert 0 and increase structural safety.

The recess part 5 may extend from an outer circumferential surface of the cutting part 1 to an outer circumferential surface of the coupling part B along an outer circumferential surface of the connection part 3 and be recessed toward the clamping part C. That is, the recess part 5 may provide a space and a path through which a chip generated when the cutting insert 0 cuts the workpiece is discharged to the outside.

Thus, the chip generated when cutting the workpiece may be prevented as much as possible from being caught between the cutting insert 0 and the cutting tool 9, and cutting quality may be prevented as much as possible from being degraded by the chip. A detailed description on the recess part 5 will be described later.

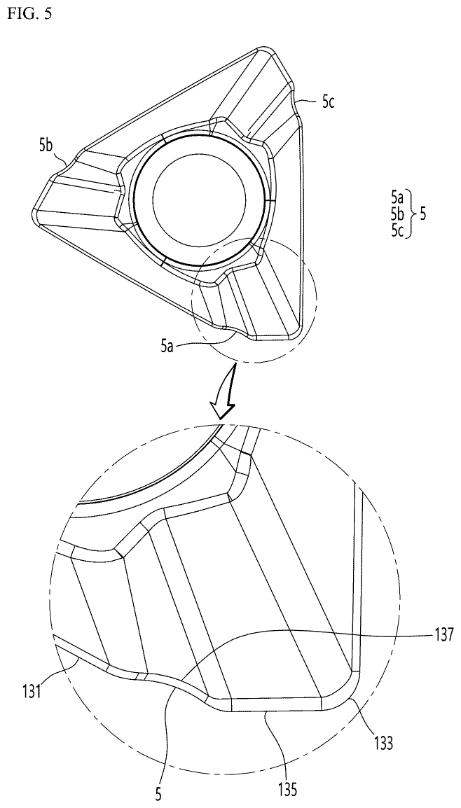

FIG. 5 is a view illustrating the recess part according to an embodiment of the present invention. Referring to FIGS. 4 and 5, the cutting part 1 according to an embodiment of the present invention may include a cutting body part 11 and a cutting edge 13.

The cutting body part 11 through which the clamping part C passes may form the top surface of the cutting insert 0. The cutting edge 13 may be disposed along an outer circumference of the cutting body part 11. Alternatively, the cutting edge 13 may be the outer circumference of the cutting body part 11. Also, the cutting edge 13 may be collectively referred to as a cutting edge.

The cutting edge 13 may include a main cutting edge 131, a corner cutting edge 133, a minor cutting edge 135, and an inclined cutting edge 137. The main cutting edge 131 may be provided in plurality to cut the workpiece. Specifically, the main cutting edge 131 may have a largest contact area with the workpiece among components of the cutting edge 13 to mainly perform cutting of the workpiece.

The corner cutting edge 133 may be provided in number corresponding to that of the main cutting edge 131. The corner cutting edge 133 may extend curvedly from the main cutting edge 131. That is, when three main cutting edges 131 are provided, three corner cutting edges 133 may be provided to assist the main cutting edges 131, thereby performing the cutting of the workpiece.

The minor cutting edge 135 are provided in number corresponding to that of the corner cutting edge 133. The minor cutting edge 135 may extend from the corner cutting edge 133 to cut the workpiece. That is, when three corner cutting edges 133 are provided, three minor cutting edges 135 may be provided to assist the main cutting edges 131, thereby performing the cutting of the workpiece.

The inclined cutting edge 137 may have one end connected to the minor cutting edge 135 and the other end connected to the main cutting edge 131. Also, the inclined cutting edge 137 may be provided in number corresponding to that of the minor cutting edge 135. For example, when three minor cutting edges 135 are provided, three inclined cutting edges 137 may be provided. Furthermore, the inclined cutting edge 137 may assist the main cutting edge 131 to perform the cutting of the workpiece.

Also, the recess part 5 may extend from the inclined cutting edge 137 to the coupling part B along the connection part 3. That is, the recess part 5 may be disposed at a position corresponding to the inclined cutting edge 137 to constantly maintain the cutting function in which the main cutting edge 131 plays a key role in cutting and discharge a plurality of chips generated during the cutting of the main cutting edge 131.

Also, the recess part 5 may extend continuously to the coupling part B along the connection part 3 and have a radius of curvature of 0.5 to 3. That is, the recess part 5 may be provided continuously from the cutting part 1 to the coupling part B to more efficiently discharge the generated chip.

Also, the recess part 5 may efficiently discharge the chip generated during the cutting while maintaining structural rigidity of the cutting insert 0 and maintain a function of the inclined cutting edge 137 due to the radius of curvature of 0.5 to 3.

Furthermore, the recess part 5 may more efficiently discharge the chip generated during the cutting while more efficiently maintaining the structural rigidity of the cutting insert 0 and further maintain the function of the inclined cutting edge 137 due to the radius of curvature of 1.5 to 2.5.

Preferably, the recess part 5 may more efficiently discharge the chip generated during the cutting while more efficiently maintaining the structural rigidity of the cutting insert 0 and further maintain the function of the inclined cutting edge 137 when the recess part 5 has a radius of curvature of 1.8 to 2.2.

Referring to FIGS. 4 and 5 again, the main cutting edge 131 according to an embodiment of the present invention may include a first main cutting edge 131a, a second main cutting edge 131b, and a third main cutting edge 131c. That is, as described above, the main cutting edge 131 may be provided in plurality, and specifically three main cutting edges may be provided. The three main cutting edges 131 may include a first main cutting edge 131a, a second main cutting edge 131b, and a third main cutting edge 131c.

The corner cutting edge 133 may include a first corner cutting edge 133a, a second corner cutting edge 133b, and a third corner cutting edge 133c. The first corner cutting edge 133a may be connected to the first main cutting edge 131a, the second corner cutting edge 133b may be connected to the second main cutting edge 131b, and the third corner cutting edge 133c may be connected to the third main cutting edge 131c.

That is, as described above, the corner cutting edge 133 may be provided in number corresponding to that of the main cutting edge 131, and specifically three corner cutting edges may be provided. The three corner cutting edges 133 may include a first corner cutting edge 133a, a second corner cutting edge 133b, and a third corner cutting edge 133c.

The minor cutting edge 135 may include a first minor cutting edge 135a, a second minor cutting edge 135b, and a third minor cutting edge 135c. The first minor cutting edge 135a may extend from the first corner cutting edge 133a to the second main cutting edge 131b. The second minor cutting edge 135b may extend from the second corner cutting edge 133b to the third main cutting edge 131c. The third minor cutting edge 135c may extend from the third corner cutting edge 133c to the first main cutting edge 131a.

That is, as described above, the minor cutting edge 135 may be provided in number corresponding to that of the corner cutting edge 133, and specifically three minor cutting edges may be provided. The three minor cutting edges 135 may include a first minor cutting edge 135a, a second minor cutting edge 135b, and a third minor cutting edge 135c.

The inclined cutting edge 137 may include a first inclined cutting edge 137a, a second inclined cutting edge 137b, and a third inclined cutting edge 137c. The first inclined cutting edge 137a may connect the first minor cutting edge 135a to the second main cutting edge 131b. The second inclined cutting edge 137b may connect the second minor cutting edge 135b to the third main cutting edge 131c. The third inclined cutting edge 137c may connect the third minor cutting edge 135c to the first main cutting edge 131a.

That is, as described above, the inclined cutting edge 137 may be provided in number corresponding to that of the minor cutting edge 135, and specifically three inclined cutting edges may be provided. The three inclined cutting edges 137 may include a first inclined cutting edge 137a, a second inclined cutting edge 137b, and a third inclined cutting edge 137c.

Also, the recess part 5 may include a first recess part 5a, a second recess part 5b, and a third recess part 5c. The first recess part 5a may be disposed at the first inclined cutting edge 137a, the second recess part 5b may be disposed at the second inclined cutting edge 137b, and the third recess part 5c may be disposed at the third inclined cutting edge 137c.

That is, the recess part 5 may be provided in number corresponding to that of the inclined cutting edge 137, and specifically three recess parts 5 may be provided. The three recess parts 5 may be the first recess part 5a, the second recess part 5b, and the third recess part 5c.

In summary, the cutting part 1 of the cutting insert 0 may have an overall triangular shape, and the coupling part B of the cutting insert 0 may also have an overall triangular shape corresponding to that of the cutting part 1 of the cutting insert 0.

Also, one recess part 5 may be provided on one side of the overall triangular shape. That is, the cutting insert 0 may have a triangular shape with three sides having the same shape.

Specifically, each of the first main cutting edge 131a, the second main cutting edge 131b, and the third main cutting edge 131c may be a curve having a radius of curvature greater than a predetermined value. That is, when viewed from above, each of the first main cutting edge 131a, the second main cutting edge 131b, and the third main cutting edge 131c may have a radius of curvature similar to a straight line and perform the cutting easily.

Also, each of the first corner cutting edge 133a, the second corner cutting edge 133b, and the third corner cutting edge 133c may have an acute angle. That is, when viewed from above, the first corner cutting edge 133a may have one end connected to the first main cutting edge 131a, the other end connected to the first minor cutting edge 135a, and a center bent to form an acute angle.

Also, when viewed from above, the second corner cutting edge 133b may have one end connected to the second main cutting edge 131b, the other end connected to the second minor cutting edge 135b, and a center bent to form an acute angle.

Also, when viewed from above, the third corner cutting edge 133c may have one end connected to the third main cutting edge 131c, the other end connected to the third minor cutting edge 135c, and a center bent to form an acute angle.

Each of the first corner cutting edge 133a, the second corner cutting edge 133b, and the third corner cutting edge 133c may form an angle of 50° to 70° and increase the overall structural rigidity of the cutting insert 0. Preferably, each of the first corner cutting edge 133a, the second corner cutting edge 133b, and the third corner cutting edge 133c may form an angle of 55° to 65° and more efficiently increase the overall structural rigidity of the cutting insert 0.

Also, each of the first minor cutting edge 135a, the second minor cutting edge 135b, and the third minor cutting edge 135c may extend to be flat. That is, when viewed from above, each of the first minor cutting edge 135a, the second minor cutting edge 135b, and the third minor cutting edge 135c may extend in the form of a straight line.

Also, each of centers of the first inclined cutting edge 137a, the second inclined cutting edge 137b, and the third inclined cutting edge 137c may be recessed toward the clamping part C. That is, the first inclined cutting edge 137a may have one end connected to the first minor cutting edge 135a, the other end connected to the second main cutting edge 131b, and a center recessed inward to form the recess part 5, so that the chip is easily discharged during the cutting. Also, since the first inclined cutting edge 137a extends obliquely to be spaced apart from the coupling part B from the other end to one end when viewed from the side, the cutting may be performed at various angles to improve the cutting efficiency.

Also, the second inclined cutting edge 137b may have one end connected to the second minor cutting edge 135b, the other end connected to the third main cutting edge 131c, and a center recessed inward to form the recess part 5, so that the chip is easily discharged during the cutting. Also, since the second inclined cutting edge 137b extends obliquely to be spaced apart from the coupling part B from the other end to one end when viewed from the side, the cutting may be performed at various angles to improve the cutting efficiency.

Also, the third inclined cutting edge 137c may have one end connected to the third minor cutting edge 135c, the other end connected to the first main cutting edge 131a, and a center recessed inward to form the recess part 5, so that the chip is easily discharged during the cutting. Also, since the third inclined cutting edge 137c extends obliquely to be spaced apart from the coupling part B from the other end to one end when viewed from the side, the cutting may be performed at various angles to improve the cutting efficiency.

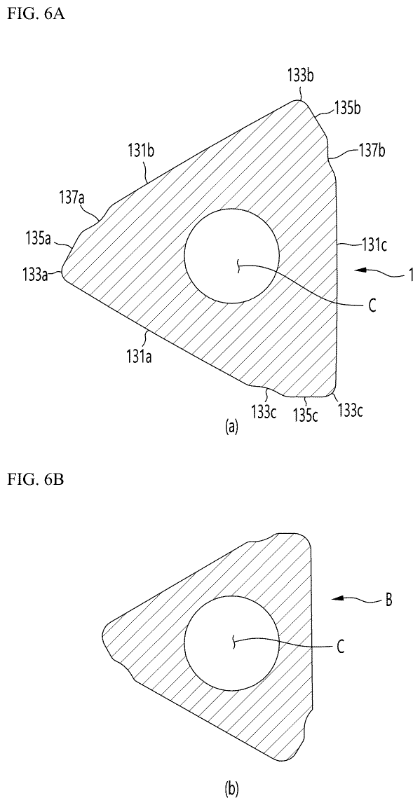

FIG. 6 is an area view illustrating the coupling part and cutting part of the cutting insert according to an embodiment of the present invention. Specifically, FIG. 6(a) is an area view of the cutting part, and FIG. 6(b) is an area view of the coupling part. Referring to FIGS. 4 and 6, the connection part 3 according to an embodiment of the present invention may include a first connection part 3a, a second connection part 3b, and a third connection part 3c.

Also, the first connection part 3a may be connected to the first main cutting edge 131a, the third inclined cutting edge 137c, and the third minor cutting edge 135c. The second connection part 3b may be connected to the second main cutting edge 131b, the first inclined cutting edge 137a, and the first minor cutting edge 135a. The third connection part 3c may be connected to the third main cutting edge 131c, the second inclined cutting edge 137b, and the second minor cutting edge 135b.

That is, each of the cutting part 1 and the coupling part B may have an overall triangular cross-sectional shape, and three connection parts 3 connecting the cutting part 1 and the coupling part B may be provided to form the overall shape of the cutting insert 0. Specifically, the cutting part 1 may have a cross-sectional area greater than that of the coupling part B, and the connection part 3 may extend obliquely from the cutting part 1 to the coupling part B toward a center of the clamping part C. Accordingly, since a space may be defined between the connection part 3 and the workpiece, the chip generated during the cutting may be smoothly discharged to improve overall cutting quality.

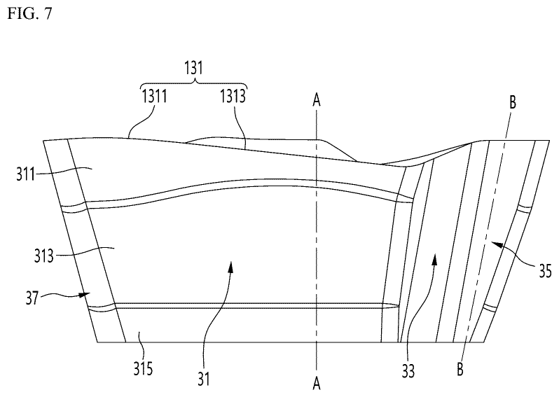

FIG. 7 is a side view illustrating the cutting insert according to an embodiment of the present invention. Referring to FIGS. 5 to 7, the connection part 3 according to an embodiment of the present invention may include a main cutting connection part 31, an inclined cutting connection part 33, a minor cutting connection part 35, and a corner cutting connection part 37.

The main cutting connection part 31 may be connected to the main cutting edge 131, the inclined cutting connection part 33 may be connected to the inclined cutting edge 137, the minor cutting connection part 35 may be connected to the minor cutting edge 135, and the corner cutting connection part 37 may be connected to the corner cutting edge 133.

That is, the main cutting connection part 31 may extend between the main cutting edge 131 and the coupling part B, the inclined cutting connection part 33 may extend between the inclined cutting edge 137 and the coupling part B, the assistant cutting connecting part 35 may extend between the minor cutting edge 135 and the coupling part B, and the corner cutting connection part 37 may extend between the corner cutting edge 133 and the coupling part B.

Also, the first connection part 3a, the second connection part 3b, and the third connection part 3c may each include the main cutting connection part 31, the inclined cutting connection part 33, the minor cutting connection part 35, and the corner cutting connection part 37 and be connected to each other to form one continuous surface.

An angle between an extension line of the main cutting connection part 31 and an extension line of the minor cutting connection part 35 may be an obtuse angle, and the inclined cutting connection part 33 may be recessed inward toward the clamping part C to form the recess part 5.

That is, as the extension line of the main cutting connection part 31 and the extension line of the minor cutting connection part 35 form the obtuse angle, the recess part 5 may be easily formed in the inclined cutting connection part 33 to improve the overall cutting quality.

Specifically, the extension line of the main cutting connection part 31 and the extension line of the minor cutting connection part 35 may form an angle of 100° to 170°. Preferably, as the extension line of the main cutting connection part 31 and the extension line of the minor cutting connection part 35 form an angle of 110° to 160°, the recess part 5 may be easily formed in the inclined cutting connection part 33 to improve the overall cutting quality.

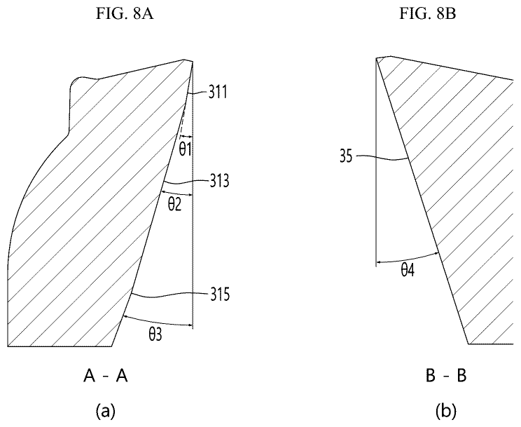

FIG. 8 is a cross-sectional view of FIG. 7. Specifically, FIG. 8(a) is a cross-sectional view taken along line A-A, and FIG. 8(b) is a cross-sectional view taken along line B-B. Referring to FIGS. 7 and 8, the main cutting connection part 31 according to an embodiment of the present invention may include a main cutting upper connection part 311, a main cutting central connection part 313, and a main cutting lower connection part 315.

The main cutting connection parts 31 disposed on each of the first connection part 3a, the second connection part 3b, and the third connection part 3c may include the main cutting upper connection part 311, the main cutting central connection part 313, and the main cutting lower connection part 315.

The main cutting upper connection part 311 may be connected to the main cutting edge 131. That is, the main cutting upper connection part 311 may be disposed at an uppermost end of the main cutting connection part 31 when viewed from the side. Also, the main cutting upper connection part 311 may extend to be curved by a predetermined length to form a curved surface. Thus, the cutting quality may be improved when cutting a side surface of the workpiece.

The main cutting central connection part 313 may extend from the main cutting upper connection part 311 toward the coupling part B in the form of a flat surface. The main cutting lower connection part 315 may extend from the main cutting central connection part 313 to the coupling part B in the form of a flat surface. Also, the main cutting lower connection part 315 may extend at an angle different from that of the main cutting central connection part 313 to perform cutting at various angles.

Specifically, an angle θ1 formed between an outer end of the main cutting upper connection part 311 and a central axis CO of the clamping part C may be 8° to 12°, an angle θ2 formed between an outer end of the main cutting connection part 31 and the central axis of the clamping part C may be 14° to 18°, and an angle θ3 formed between an outer end of the main cutting lower connection part 315 and the central axis of the clamping part C may be 18° to 22°.

Accordingly, as the cutting insert 0 is gradually tapered in an extension direction from the main cutting upper connection part 311 to the main cutting lower connecting part 315 while efficiently maintaining the structural rigidity, a space may be sufficiently secured between the workpiece and the cutting insert 0 to easily discharge the cut chip.

More specifically, the angle θ1 formed between the outer end of the main cutting upper connection part 311 and the central axis of the clamping part C may be 9.5° to 10.5°, the angle θ2 formed between the outer end of the main cutting connection part 31 and the central axis of the clamping part C may be 15.5° to 16.5°, and the angle θ3 formed between the outer end of the main cutting lower connection part 315 and the central axis of the clamping part C may be 19.5° to 20.5°. Thus, the chip may be more easily discharged while more efficiently maintaining the structural rigidity of the cutting insert 0.

Preferably, the angle θ1 formed between the outer end of the main cutting upper connection part 311 and a central axis of the clamping part C may be 9.8° to 10.2°, the angle θ2 formed between the outer end of the main cutting connection part 31 and the central axis of the clamping part C may be 15.8° to 16.2°, and the angle θ3 formed between an outer end of the main cutting lower connection part 315 and the central axis of the clamping part C may be 19.8° to 20.2°. Thus, the chip may be more easily discharged while more efficiently maintaining the structural rigidity of the cutting insert 0.

Also, the angle formed between the outer end of the main cutting upper connection part 311 and the central axis of the clamping part C may be less than an angle formed between an outer end of the minor cutting connection part 35 and the central axis of the clamping part C. Accordingly, a cutting performance of the cutting insert 0 may be enhanced, and the chip may be more easily discharged.

Specifically, the angle formed between the outer end of the minor cutting connection part 35 and the central axis of the clamping part C may be 16° to 20° to improve the cutting performance of the cutting insert 0 and easily discharge the chip.

More specifically, the angle formed between the outer end of the minor cutting connection part 35 and the central axis of the clamping part C may be 17.5° to 18.5° to further improve the cutting performance of the cutting insert 0 and more easily discharge the chip.

Preferably, the angle formed between the outer end of the minor cutting connection part 35 and the central axis of the clamping part C may be 17.8° to 18.2° to further improve the cutting performance of the cutting insert 0 and more easily discharge the chip.

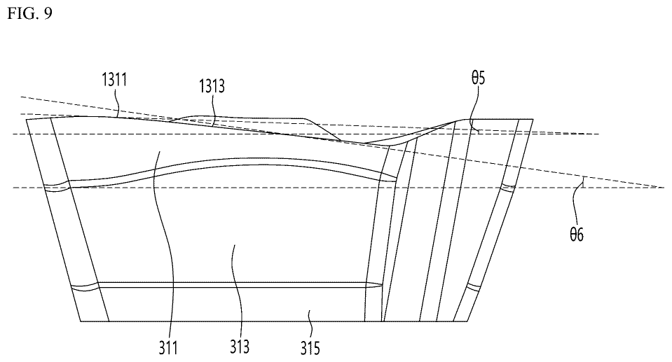

FIG. 9 is a view illustrating an angle formed between components of the cutting insert according to an embodiment of the present invention. Referring to FIG. 9, the main cutting edge 131 according to an embodiment of the present invention may include a corner connection main cutting edge 1311 and an inclined connection main cutting edge 1313. Each of the first main cutting edge 131a, the second main cutting edge 131b, and the third main cutting edge 131c may include the corner connection main cutting edge 1311 and the inclined connection main cutting edge 1313.

The corner connection main cutting edge 1311 may be connected to the corner cutting edge 133, and the inclined connection main cutting edge 1313 may extend from the corner connection main cutting edge 1311 toward the inclined cutting edge 137 and be inclined at an angle greater than that of the corner connection main cutting edge 1311.

That is, the main cutting edge 131 may have an inclination that is gradually increased in a direction from the corner cutting edge 133 to the inclined cutting edge 137 to distribute stress concentrated on the corner cutting edge 133, thereby improving durability and maintaining overall the cutting efficiency.

Specifically, an angle formed between a tangent line of the corner connecting main cutting edge 1311 and the coupling part B may be 0° to 4°, and an angle formed between a tangent line of the inclined connection main cutting edge 1313 and the coupling part B may be 3° to 7°. Accordingly, the corner connecting main cutting edge 1311 may effectively distribute the stress concentrated on the corner cutting edge 133 to improve the durability, and the inclined connection main cutting edge 1313 may maintain the overall cutting performance.

More specifically, the angle formed between the tangent line of the corner connecting main cutting edge 1311 and the coupling part B may be 1.5° to 2.5°, and the angle formed between the tangent line of the inclined connection main cutting edge 1313 and the coupling part B may be 4.5° to 5.5°. Accordingly, the corner connecting main cutting edge 1311 may more effectively distribute the stress concentrated on the corner cutting edge 133 to further improve the durability, and the inclined connection main cutting edge 1313 may further maintain the overall cutting performance.

Preferably, the angle formed between the tangent line of the corner connecting main cutting edge 1311 and the coupling part B may be 1.8° to 2.2°, and the angle formed between the tangent line of the inclined connection main cutting edge 1313 and the coupling part B may be 4.8° to 5.2°. Accordingly, the corner connecting main cutting edge 1311 may more effectively distribute the stress concentrated on the corner cutting edge 133 to further improve the durability, and the inclined connection main cutting edge 1313 may further maintain the overall cutting performance.

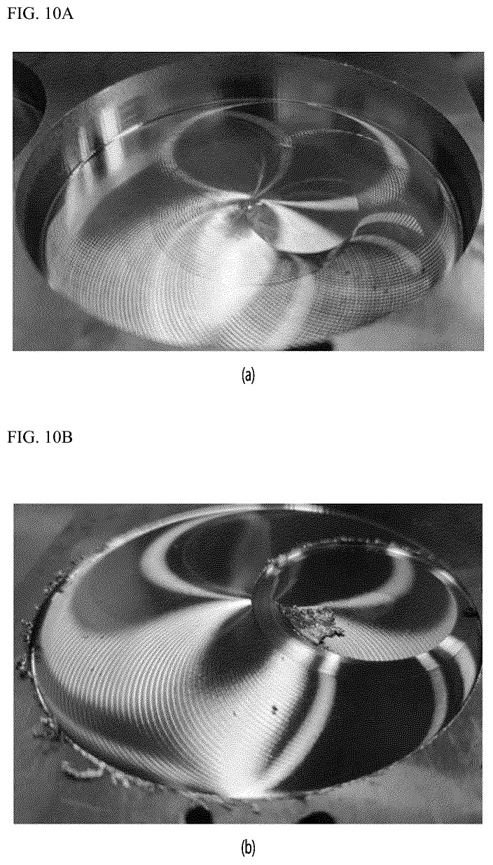

FIG. 10 is a photograph showing cutting quality comparison between a conventional cutting insert and the cutting insert according to an embodiment of the present invention. Specifically, FIG. 10(a) is a photograph showing the workpiece on which the cutting is performed by the cutting insert 0 according to embodiments of the present invention, and FIG. 10(b) is a photograph showing the workpiece on which the cutting is performed by a conventional cutting insert 0′.

Referring to FIG. 10, when the cutting is performed by the cutting insert 0 according to the embodiments of the present invention, it may be confirmed that the chip is smoothly discharged without being caught between the cutting insert 0 and the cutting tool 9 to minimize generation of vibration and perform a smooth and stable processing on a surface of the workpiece.

On the contrary, when the cutting is performed by the conventional cutting insert 0′, it may be confirmed that the chip is caught between the cutting insert 0 and the cutting tool 9 to cause degradation of surface roughness of a processed surface and a damage of the tool, thereby stopping the processing.

That is, it may be known through experimental results of FIG. 10 that the cutting quality of the cutting insert 0 according to the embodiments of the present invention is significantly superior to that of the conventional cutting insert 0′.

The embodiments of the present invention may provide the cutting insert that easily discharges the chip during the cutting by including the recess part.

Also, the embodiments of the present invention may provide the cutting insert in which the corner connection main cutting edge has the inclination less than that of the inclined connection main cutting edge to distribute the stress concentration of the corner cutting edge, thereby improving the durability.

Also, the embodiments of the present invention may provide the cutting insert that has the improved cutting performance and easily discharges the chip through the optimized design of the connection part.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed. Hence, the real protective scope of the present invention shall be determined by the technical scope of the accompanying claims.

What is claimed is:

1. A cutting insert comprising:
a coupling part coupled to a tool;
a cutting part spaced apart from the coupling part to cut a workpiece;
a connection part configured to connect the cutting part and the coupling part;
a clamping part configured to pass through the coupling part, the cutting part, and the connection part; and
a recess part extending from an outer circumferential surface of the cutting part to an outer circumferential surface of the coupling part along an outer circumferential surface of the connection part and recessed toward the clamping part,
wherein the cutting part comprises:
a cutting body part through which the clamping part passes; and
a cutting edge disposed along an outer circumference of the cutting body part,
wherein the cutting edge comprises:
a main cutting edge provided in plurality to cut the workpiece;
a corner cutting edge provided in number corresponding to that of the main cutting edge and extending curvedly from the main cutting edge;
a minor cutting edge provided in number corresponding to that of the corner cutting edge and extending from the corner cutting edge to cut the workpiece; and
an inclined cutting edge having one end connected to the minor cutting edge and the other end connected to the main cutting edge,
wherein the recess part extends from the inclined cutting edge to the coupling part along the connection part.

2. The cutting insert of claim 1, wherein the recess part extends continuously to the coupling part along the connection part and has a radius of curvature of 0.5 to 3.

3. The cutting insert of claim 2, wherein the recess part has a radius of curvature of 1.5 to 2.5.

4. The cutting insert of claim 3, wherein the main cutting edge comprises a first main cutting edge, a second main cutting edge, and a third main cutting edge,
the corner cutting edge comprises a first corner cutting edge connected to the first main cutting edge, a second corner cutting edge connected to the second main cutting edge, and a third corner cutting edge connected to the third main cutting edge,
the minor cutting edge comprises a first minor cutting edge extending from the first corner cutting edge to the second main cutting edge, a second minor cutting edge extending from the second corner cutting edge to the third main cutting edge, and a third minor cutting edge extending from the third corner cutting edge to the first main cutting edge, and
the inclined cutting edge comprises a first inclined cutting edge configured to connect the first minor cutting edge and the second main cutting edge, a second inclined cutting edge configured to connect the second minor cutting edge and the third main cutting edge, and a third inclined cutting edge configured to connect the third minor cutting edge and the first main cutting edge.

5. The cutting insert of claim 4, wherein the recess part comprises a first recess part defined in the first inclined cutting edge, a second recess part defined in the second inclined cutting edge, and a third recess part defined in the third inclined cutting edge.

6. The cutting insert of claim 5, wherein each of the first main cutting edge, the second main cutting edge, and the third main cutting edge extends in the form of a curve having a radius of curvature equal to or greater than a predetermined value, each of the first corner cutting edge, the second corner cutting edge, and the third corner cutting edge has an acute angle, each of the first minor cutting edge, the second minor cutting edge, and the third minor cutting edge extends to be flat, and centers of the first inclined cutting edge, the second inclined cutting edge, and the third inclined cutting edge are recessed toward the clamping part.

7. The cutting insert of claim 6, wherein the connection part comprises:
a first connection part connected to the first main cutting edge, the third inclined cutting edge, and the third minor cutting edge;
a second connection part connected to the second main cutting edge, the first inclined cutting edge, and the first minor cutting edge; and
a third connection part connected to the third main cutting edge, the second inclined cutting edge, and the second minor cutting edge.

8. The cutting insert of claim 1, wherein the cutting part has an area greater than that of the coupling part, and
the connection part extends obliquely from the cutting part to the coupling part toward the center of the clamping part.

9. The cutting insert of claim 8, wherein the connection part comprises:
a main cutting connection part connected to the main cutting edge;
an inclined cutting connection part connected to the inclined cutting edge; and
a minor cutting connection part connected to the minor cutting edge.

10. The cutting insert of claim 9, wherein an angle between an extension line of the main cutting connection part and an extension line of the minor cutting connection part is an obtuse angle, and the inclined cutting connection part is recessed inward toward the clamping part to form the recess part.

11. The cutting insert of claim 10, wherein the main cutting connection part comprises:
a main cutting upper connection part connected to the main cutting edge;
a main cutting central connection part extending from the main cutting upper connection part to the coupling part; and
a main cutting lower connection part extending from the main cutting central connection part to the coupling part.

12. The cutting insert of claim 11, wherein an angle between an outer end of the main cutting upper connection part and a central axis of the clamping part is 8° to 12°,
an angle between an outer end of the main cutting central connection part and the central axis of the clamping part is 14° to 18°, and
an angle between an outer end of the main cutting lower connection part and the central axis of the clamping part is 18° to 22°.

13. The cutting insert of claim 12, wherein an angle between the outer end of the main cutting upper connection part and the central axis of the clamping part is 9.5° to 10.5°,
an angle between the outer end of the main cutting central connection part and the central axis of the clamping part is 15.5° to 16.5°, and
an angle between the outer end of the main cutting lower connection part and the central axis of the clamping part is 19.5° to 20.5°.

14. The cutting insert of claim 13, wherein the angle between the outer end of the main cutting upper connection part and the central axis of the clamping part is less than that between an outer end of the minor cutting connection part and the central axis of the clamping part.

15. The cutting insert of claim 14, wherein an angle between the outer end of the minor cutting connection part and the central axis of the clamping part is 16° to 20°.

16. The cutting insert of claim 15, wherein an angle between the outer end of the minor cutting connection part and the central axis of the clamping part is 17.5° to 18.5°.

17. The cutting insert of claim 1, wherein the main cutting edge comprises:
a corner connection main cutting edge connected to the corner cutting edge; and
an inclined connection main cutting edge extending from the corner connection main cutting edge to the inclined cutting edge and having an inclination greater than that of the corner connection main cutting edge.

18. The cutting insert of claim 17, wherein an angle between a tangent line of the corner connection main cutting edge and the coupling part is 0° to 4°, and an angle between a tangent line of the inclined connection main cutting edge and the coupling part is 3° to 7°.

19. The cutting insert of claim 18, wherein an angle between the tangent line of the corner connection main cutting edge and the coupling part is 1.5° to 2.5°, and an angle between the tangent line of the inclined connection main cutting edge and the coupling part is 4.5° to 5.5°.

20. A cutting insert comprising:
a coupling part coupled to a tool;
a cutting part spaced apart from the coupling part to cut a workpiece;
a connection part configured to connect the cutting part and the coupling part; and
a clamping part configured to pass through the coupling part, the cutting part, and the connection part,
wherein the cutting part comprises:
a cutting body part through which the clamping part passes; and
a cutting edge disposed along an outer circumference of the cutting body part,
wherein the cutting edge comprises:
a main cutting edge provided in plurality to cut the workpiece;
a corner cutting edge provided in number corresponding to that of the main cutting edge and extending curvedly from the main cutting edge;
a minor cutting edge provided in number corresponding to that of the corner cutting edge and extending from the corner cutting edge to cut the workpiece; and
an inclined cutting edge having one end connected to the minor cutting edge and the other end connected to the main cutting edge,
wherein the cutting part has an area greater than that of the coupling part, and
the connection part extends to be tapered from the cutting part to the coupling part toward a center of the clamping part.
